(19) United States
(12) Patent Application Publication
(10) Pub. No.: US 2016/0097024 A1
(43) Pub. Date: Apr. 7, 2016

(54) Alcohol Reduction In Beverages

(71) Applicant: Memstar Pty Ltd, Nuriootpa (AU)

(72) Inventor: David Wollan, Prahran (AU)

(21) Appl. No.: 14/971,056

(22) Filed: Dec. 16, 2015

Related U.S. Application Data
(63) Continuation of application No. 10/563,636, filed on Mar. 14, 2008, now abandoned.

(30) Foreign Application Priority Data
Jun. 9, 2004 (AU) AUSN 2004903139
Dec. 21, 2004 (AU) AUSN 2004907247

(51) Int. Cl. C12G 3/08

(52) U.S. Cl. CPC C12G 3/085

(57) ABSTRACT

A method of reducing the ethanol content of a beverage which includes ethanol and volatile component is disclosed. The method may include separating the beverage into first and second streams with the first stream including ethanol and the volatile components and the second stream including ethanol but none or little of the volatile components. The method may also include contacting the second stream with a strip solution to produce a treated second stream to reduce the ethanol concentration. The method may also include mixing the treated second stream with the first stream whereby the ethanol content of the beverage is reduced but the volatile components remain substantially unchanged.

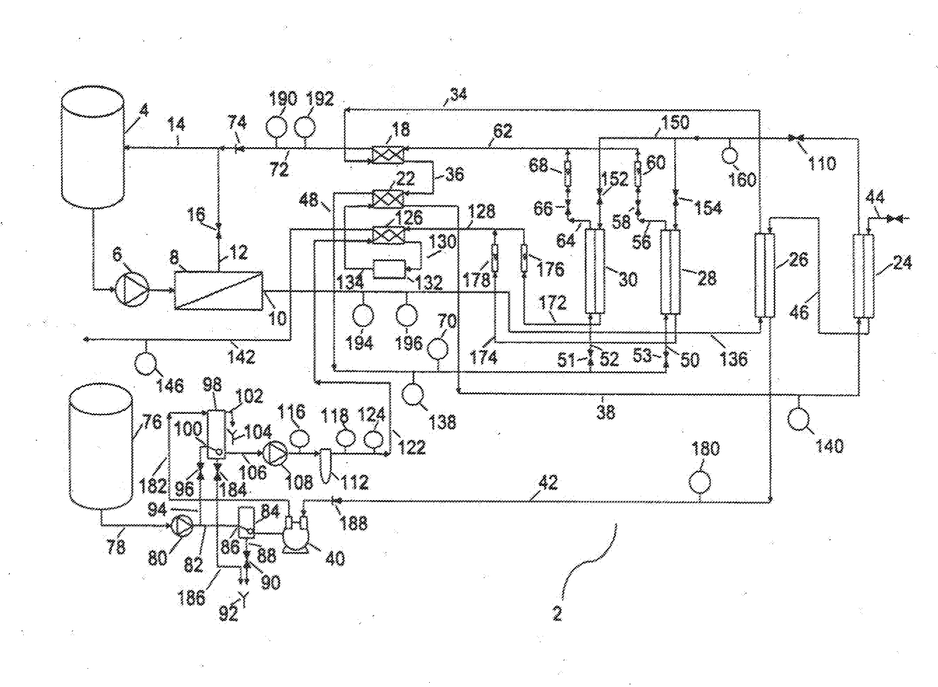

### CROSS-REFERENCE TO RELATED APPLICATIONS

This application is a continuation of U.S. patent application Ser. No. 10/563,636 filed on Mar. 14, 2008. This application is a National Stage of International Application No. PCT/AU2005/000814, filed Jun. 7, 2005, which claims the priority of AUSN 2004903139, filed Jun. 9, 2004 and AUSN 2004907247, filed Dec. 21, 2004. The entire disclosure of each of the above applications is incorporated herein by reference.

### FIELD

The present disclosure relates to a method of reducing the ethanol content of a beverage which includes ethanol and a volatile component.

### BACKGROUND AND SUMMARY

The level of alcohol in beverages such as wine is an important determinant of its perceived quality. It is, in turn, largely determined by the level of sugar in the grapes from which it is produced. Low levels of alcohol are commonly associated with grapes grown in cooler climates or seasons. Less positively they are also a result of under-ripe or over-irrigated grapes and in these instances are seen as an indicator of low quality wine. High levels of alcohol are, as a result, deemed to be associated with fully ripe fruit and higher quality. This is not a consequence of the higher alcohol per se but rather the more mature fruit flavours, tannins and lower acidity of grapes picked at optimum ripeness. In fact the pursuit of greater ripeness by winemakers in many parts of the world has resulted in wines with excessive alcohol. Besides increasing the intoxicating effect of the wine, this manifests itself in a reduced perception of wine aroma as well as an unpleasant hotness on the palate.

A measure of the extent of this problem shows it is growing at a worrisome rate. Wine samples analysed by the Australian Wine Research Institute over the past 20 years have shown a steady increase in alcohol level over this period so that the mean for all samples analysed in 2002 was 14.2% compared with 12.4% in 1984. These elevated alcohol levels can have other damaging effects on wine quality such as prolonged or arrested primary and secondary fermentations, leading to higher levels of residual sugar, with consequent microbiological spoilage, loss of SO.sub.2 and oxidation. (AWRI 2003 Annual Report p 44).

A method for removing some of this alcohol would allow winemakers to pick their grapes at optimum ripeness from the point of view of flavour maturity without suffering the negative effects of excessive alcohol.

Processes for reducing alcohol have been offered previously but all are deficient in some way.

The simplest method for reducing alcohol is to add water to the grape must or wine. While this has been practised for centuries, it diminishes wine quality by reducing the overall concentration of the wine. It is also illegal in many jurisdictions.

A more effective procedure is to remove alcohol using a low temperature distillation technique such as the spinning cone. In this, volatile components of the wine, including alcohol, are removed in the distillate and the volatile flavours are separated from this and returned to the wine being treated. This system is complex, capital intensive and immobile. There is also some possibility of flavour loss, but most importantly, the alcohol is removed at relatively low strength (<50% v/v) so overall volume loss from the wine is significant.

Another technique is proposed in Patent Specification No. AU B 42319/93. In this proposal wine is processed through a reverse osmosis plant to generate a permeate stream which consists substantially of water, alcohol and low concentrations of some other minor components. The permeate stream is then distilled in a high energy distillation column and the distillate which consists very substantially of high strength alcohol, is removed as a useful by-product. The residual material, being dealcoholised permeate, is returned to the wine, thus reducing its alcohol content. This is effective but costly in energy terms as well as infrastructure costs.

According to Williams Williams L. Distilled Beverage Technology, course notes, UC Davis 1981, “Because of this non-ideality, the relative volatility of ethanol with respect to water varies greatly. It is very large (10 to 11) in dilute solutions and decreases to 1.0 at the azeotropic concentration . . . . Thus alcohol enrichment is very large at low concentrations and one may say that distillation is “easily achieved” in this region. At high alcohol concentrations, the enrichment is small and thus, distillation to very high concentration is “difficult or costly” (in terms of energy, equipment size or both).”

As well, in many jurisdictions distillation is strictly regulated because of the inherently hazardous nature of the high strength alcoholic spirit produced as well as its interest to taxation authorities for excise revenue purposes. This means that the distillation process must be conducted in licensed premises which are usually remote from the wine being processed. This necessitates the wine or permeate being shipped from the winery to the distillation premises and the dealcoholised permeate being returned. Besides the freight costs and delays of this, in some jurisdictions it is mandatory for the dealcoholised permeate to be recombined only with the wine from which it was originally removed. This means batches must be handled discretely, reducing the prospects of scale economies and, more importantly, the dealcoholised permeate is microbiologically unstable and will quickly deteriorate unless preserved by refrigeration or chemical stabilisers.

Another option practised in jurisdictions where this is allowed, is to remove a certain amount of permeate by reverse osmosis and to replace it with the same amount of water. This water could be from grape or non-grape sources according to the local regulations but in most wine producing countries the practice is illegal or of dubious status. Another deficiency of this approach is that the permeate which is discarded does contain some other, minor components that would be lost and so the quality of the wine may be slightly diminished.

An approach described by Hogan et al: Osmotic Distillation Chemical Engineering Progress 1997 and A New Option: Osmotic Distillation, Chemical Engineer Progress July 1998 uses the process of evaporative perstraction to remove alcohol from wine. This technique is also disclosed in Patent Specification No. AU 199717793 B2 and involves passing a stream of wine through a membrane contactor such as a Liqui-Cel™ Extra-Flow produced by Membrana. Separated from the wine stream by an hydrophobic membrane, a counterflow of water is passed through the same contactor and alcohol passes through the membrane from the wine to the water. This process is based on the principle that ethanol, as a volatile wine component, has a significant vapour pressure. This leads to its movement into the porous matrix of the hydrophobic membrane and by virtue of the concentration difference across the membrane, its subsequent dissolution into the water on the other side.

In practice this results in high levels of extraction of other desirable volatile components from the wine, such as flavours, esters and sulphur dioxide. One approach suggested by the developers of this technique was to “spike” the strip solution with these compounds so that no concentration gradient for the compound exists. This is complex and expensive and renders the by-product less useful. Other efforts to limit the extraction of desirable volatiles by recycling some of the strip stream reduce the efficiency of the process. Efficiency is also compromised by the presence of relatively large concentrations of CO.sub.2 and other gases in wine. These cannot easily be removed without also removing desirable volatiles.

The object of the present invention is to provide an improved technique of dealcoholisation of beverages which minimises extraction of desirable volatile components from the beverage.

According to one aspect of the invention there is provided a method of reducing the alcohol content of an alcohol containing beverage including the steps of: (i) processing the beverage by reverse osmosis or nanofiltration for producing a retentate and a raw permeate which includes alcohol; (ii) contacting a first side of an hydrophobic microporous membrane with said raw permeate; (iii) contacting a second side of the membrane with a strip solution to extract alcohol therefrom to form a dealcoholised permeate; and (iv) combining the retentate with the dealcoholised permeate to form a dealcoholised beverage which has an alcohol content lower than that of the beverage.

Preferably, the strip solution and/or the raw permeate are heated prior to contacting the microporous membrane. It is further preferred that the strip solution and raw permeate are both heated prior to contacting the porous membrane. It will be appreciated that there will be heat conduction between the permeate and strip solution if they are not at the same temperature and therefore it would be possible, although less desirable, to heat one or other of these solutions.

Normally volatile components in wine are destroyed if the wine is heated. In the process of this aspect of the invention, however, the wine itself is not subjected to elevated temperatures but rather the permeate only is subjected to elevated temperatures. Accordingly, superior alcohol strip can be achieved without degradation of the components in the wine which give it taste and aroma. Stripping at elevated temperatures is much more efficient than stripping at lower temperatures. In the aforementioned article by Hogan et al., the stripping is necessarily carried out at low temperature otherwise the properties of the wine would be seriously downgraded. Accordingly, the process of this aspect of the invention is more efficient than that described in the aforementioned article.

Preferably, the strip solution and/or the raw permeate has a temperature in the range from about 45° C. to 50° C. when in contact with said microporous membrane.

Normally the dealcoholised permeate will be at approximately the same temperature as the strip solution and preferably the method includes the step of cooling the dealcoholised permeate prior to recombining it with the retentate.

In the process of the invention, the beverage itself is not subjected to evaporative perstraction but rather the alcohol rich permeate is subjected to the evaporative perstraction. The beverage is also not subjected to elevated temperatures.

Preferably the step of processing the beverage by reverse osmosis or nanofiltration is maintained at a temperature in the range from 13° C. to 25° C.

Where the beverage is wine, the extraction of volatiles is reduced because of their limited passage from the wine into the permeate stream. This is controlled by the selection of appropriate membranes and operating parameters such as temperature, pressure and flow rate to maximise the passage of ethanol while limiting the passage of other compounds.

Further, the efficiency of the evaporative perstraction process is improved by reducing the concentration of non-condensable gases in the membrane headspace. Trials and modelling of the process based on known vapour pressures of the gases, ethanol and water, suggest significant efficiency gains in terms of ethanol removal for given surface areas of membranes.

Efficiency of perstraction can be improved by reducing gas concentrations in the product and strip feeds.

The strip solution preferably is purified water. The water may be purified by reverse osmosis or particulate and carbon filtration.

Preferably further, the raw permeate is processed so as to remove oxygen and carbon dioxide and nitrogen therefrom prior to contacting the permeate with the microporous membrane.

Preferably further, the water also has oxygen, nitrogen and carbon dioxide removed therefrom prior to contacting with the membrane.

The alcohol in the strip solution is a useful by-product.

The invention also provides apparatus for reducing the alcohol content of an alcohol containing beverage, the apparatus including: (i) a first processing stage having a reverse osmosis unit or nanofiltration unit having a retentate outlet and permeate outlet; (ii) a pump for supplying beverage to be treated under pressure to the first processing stage whereby retentate is produced at the retentate outlet and raw permeate containing alcohol is produced at the permeate outlet; (iii) a second processing stage which includes at least one hydrophobic microporous membrane, the second processing stage having a first inlet for receiving said raw permeate and a second inlet for receiving a strip solution, the membrane being operable to allow alcohol from the raw permeate to pass therethrough to the strip solution to thereby remove at least a portion of the alcohol from the raw permeate so as to produce dealcoholised permeate at an outlet of the second processing stage; and (iv) means for combining said dealcoholised permeate with said retentate to thereby produce dealcoholised beverage in which the alcoholic content thereof is lower than that of the beverage.

Preferably, the apparatus includes heater means for heating the strip solution and/or the raw permeate to a temperature in the range from 40° C. to 70° C. and most preferably to a temperature of about 45° C. to 50° C.

Preferably further, the apparatus includes means for cooling the dealcoholised permeate prior to combining with said retentate.

The invention also provides dealcoholised beverage when made by the method or apparatus defined above.

The invention further provides a method for reducing the alcohol content of a wine including (i) processing the wine having a first alcohol concentration by reverse osmosis or nanofiltration to produce a retentate and a raw permeate, the retentate having a second alcohol concentration greater than or equal to the first alcohol concentration, and the raw permeate having a third alcohol concentration less than or equal to the first alcohol concentration; (ii) heating the raw permeate to a temperature in the range of about 40° C. to about 70° C.; (iii) heating strip water to a temperature in the range of about 40° C. to about 70° C.; (iv) after heating the raw permeate, contacting a first side of an hydrophobic microporous membrane with the raw permeate; (v) after heating the strip water, contacting a second side of the hydrophobic microporous membrane with the strip water, extracting alcohol from the raw permeate, and forming a partially dealcoholized permeate having a fourth alcohol concentration at the first side of the hydrophobic microporous membrane; and (vi) combining the retentate with the partially dealcoholized permeate and forming a partially dealcoholized wine having a fifth alcohol concentration less than the first alcohol concentration.

### DESCRIPTION OF THE DRAWING

The invention will now be described with reference to the accompanying drawing which is a schematic block diagram of a system for reducing the alcoholic content of wine or other alcoholic beverages.

### DETAILED DESCRIPTION

The diagram schematically illustrates a system 2 for producing reduced alcohol wine in accordance with the invention. The system 2 includes a tank 4 for storage of wine to be treated. Wine from the tank 4 passes to a pump 6 which pumps the wine at high pressure to a reverse osmosis unit 8. The reverse osmosis unit 8 has membranes therein which pass water and alcohol into the permeate while rejecting other desirable wine aroma, colour and taste components which are retained in the concentrated wine or retentate. The reverse osmosis unit 8 has a permeate outlet 10 and a retentate outlet 12. The outlet 12 is connected by means of a line 14 to the tank 4 for circulating the reduced alcohol wine. The line 14 includes a back pressure control valve 16 which effectively controls the pressure in the reverse osmosis system 8 and outlet 12. The membranes in the reverse osmosis unit 8 can typically be in the form of spiral wound reverse osmosis or nanofiltration membranes such as GE Osmonics VinoCon or VinoPro 8040 or 4040.

Typically the flow of wine through pump 6 is 3,500 to 12,500 litres per hour, depending on type and number of membranes used.

Typically the temperature and pressure in the reverse osmosis unit 8 and outlet 12 are in the range 13° C. to 25° C. and 1,500 kPa to 7,000 kPa.

Normally the percentage of wine passing to the retentate outlet 12 will be in the range 80% to 90% of the flow passing through pump 6.

Normally the wine in the tank 4 will have an initial alcoholic content in the range from say 13% to 16% by volume. The system of the invention seeks to reduce the alcoholic content of the wine in tank 4 to a more desirable level such as say 12.5% to 13.5%.

Typically the alcoholic level of the permeate at the raw permeate outlet 10 is 10% to 13% v/v. The flow of permeate leaving the reverse osmosis plant 8 is measured in line 10 by mag flowmeter 194. Its temperature is measured by temperature probe 196. Both of these measurements are transmitted to a separate programmable logic controller (not shown) for display and control purposes.

The system includes a first, second, third or more contactors, 24, 26, 28 and 30 arranged in a vertical orientation. Contactor 24 removes dissolved gases such as oxygen and carbon dioxide from the flow of stripping water. Contactor 26 degasses the flow of alcoholic permeate. Contactors 28, 30, and possibly others are the alcohol stripping contactors. Each of these can be of the type which includes a hydrophobic microporous membrane, for example of the type Liqui-Cel® Extra-Flow.

A line 136 is connected from the reverse osmosis outlet 10 so as to pass the raw, unheated permeate to the second contactor 26 to be degassed.

The system of the invention also includes a vacuum pump 40, the inlet of which is connected to a vacuum line 42 and includes a non-return valve 188 to prevent service water running back into line 42. The vacuum line 42 is connected to the second contactor 26 and then to the first contactor 24 by means of a line 46. The first contactor 24 has an inlet and pressure regulating valve 44 for supplying a counterflow of an inert gas such as nitrogen. Typically the flow of nitrogen is regulated to be about 400 litres per hour.

Normally the raw permeate is supplied to the shell side of the contactor whereas the vacuum is applied to the lumen side or the interior of the multiplicity of membrane tubes which pass through the contactors 24 and 26. The vacuum has the effect of removing carbon dioxide and oxygen from the stream of warm stripping water in contactor 24 and from the stream of raw permeate in contactor 26.

The system of the invention includes a heat exchanger 18 which warms the degassed permeate by counterflow heat exchange with the hot treated permeate returning in line 62. The contactor 26 is connected to the heat exchanger 18 by line 34. A line 36 is connected to the heat exchanger 18 so as to pass the degassed, pre-warmed permeate to another heat exchanger 22 which heats the permeate further by counterflow heat exchange with heated strip water. A line 48 passes the heated, degassed permeate from heat exchanger 22 to the bottom, shell side inlet of the alcohol stripping contactors 28 and 30.

The tops of contactors 28 and 30 receive a flow of degassed strip water on input line 150 from the degassing contactor 24. The alcohol stripping action takes place in the contactors 28 and 30 where the heated, degassed permeate encounters a counterflow of heated, degassed strip water and its alcohol concentration is typically reduced to 3% to 6% v/v.

Stripping contactors 28 and 30 are arranged in a parallel configuration so that the stream of degassed permeate entering from line 48 is split to line 50 before flowing upwards through contactor 28 and through line 52 to the bottom of contactor 30. Valves 51 and 53 allow contactors 28 and 30 to be isolated from the system. The hot, alcohol reduced permeate passes from contactor 28 via line 56 to a flow control valve 58 then to a flow monitoring rotameter 60 to line 62. A similar line 64, flow control valve 66 and flow monitoring rotameter 68 pass the alcohol reduced permeate from contactor 30 to line 62. A pressure transmitter 70 monitors the back pressure in the permeate lines 48, 50 and 52 and transmits its measurement to a separate controller (not shown) for display and control purposes.

The relative flows of permeate through the two contactors 28 and 30 and the pressure as measured by pressure transmitter 70 are controlled by the flow control valves 58 and 66.

The still hot reduced alcohol permeate then passes through line 62 to heat exchanger 18 where it is cooled by, and in turn pre-warms the raw, degassed permeate coming from the contactor 26 via line 34. The treated and cooled permeate from heat exchanger 18 then passes through line 72 and non return valve 74 to be mixed with the concentrated wine (retentate) in line 14 for return to tank 4. The wine returning to tank 4 therefore has a reduced alcoholic content measured by volume which is typically 0.5% to 1.5% lower than the untreated wine in tank 4. The flow rate of reduced alcohol permeate is measured by flowmeter 190 and its temperature is measured by temperature probe 192.

By comparing the temperature corrected flows in lines 10 and 72, the difference in flows correlate with the rate of alcohol removed and so provides a means of monitoring and controlling the performance of the alcohol reduction process.

In accordance with the invention, the alcohol stripping is carried out on the permeate rather than the wine itself and therefore desirable volatile components in the wine remain substantially unchanged because they remain in the retentate.

The system includes a source of water 76 which supplies water via inlet line 78 to a pressure pump 80. Preferably the water has been purified say by reverse osmosis prior to admission to the supply source 76. However, where water quality permits, this could be a mains supply. Pump 80 supplies water under pressure via line 82 to a break tank 84 which includes a float valve 86 to maintain a constant level of service or seal water for vacuum pump 40. Break tank 84 includes a line 88 and valve 90 to drain the tank to refuse point 92.

Pressure pump 80 also supplies water via line 94 to surge tank 98. Maximum flow to this tank is regulated by valve 96 and level in the tank is maintained by float valve 100. An overflow line 102 passes any excess to drain point 104. A drain line 186 with valve 184, allows the surge tank 98 to be drained to point 92 (or 104 if more convenient).

Water in the surge tank 98 then passes via line 106 to a pump 108, then on to a combined particulate and adsorbent carbon filter 112. Differential pressure across this filter is monitored by pressure gauges 116 and 118. The purpose of this filter is to remove any large solids in the water which could foul the membrane contactors and any taints which could pass the membranes; taint the permeate and then the wine.

After filter 112, the water passes through line 122 to heat exchanger 126. Flow in line 122 is monitored by flow detector switch 124 which sends a signal to a separate controller in the event of no flow in the line. The water from line 122 is pre-warmed in heat exchanger 126 by a counter flow of hot, alcoholic strip water returning from the stripping contactors via line 128. The cooled alcoholic strip water leaves heat exchanger 126 for recovery or disposal to waste via line 142. The flow of alcoholic strip water by product in line 142 is measured by a flow totaliser 146.

The pre-warmed raw strip water from heat exchanger 126 then passes through line 130 to heater 132 where it is heated to approximately 65° C. to 75° C. Heater 132 could be of whatever type—gas, electric element or heat pump—which is most appropriate for the site and the duty.

The heated strip water then passes through line 134 to heat exchanger 22 where it heats the pre-warmed, degassed permeate entering in counter flow from line 36. The heated strip water then passes through line 38 to contactor 24 for degassing. The temperature of the heated strip water in line 38 is monitored by temperature transmitter 140 which sends an analogue signal to a separate controller. The temperature of the heated permeate in line 48 is also monitored by a temperature transmitter 138. Heat exchanger 22 is sized so that the counter flows of permeate and strip water both leave heat exchanger 22 at approximately 45° C. to 55° C.

After heating in heat exchanger 22 and passing through line 38, the heated, degassed alcoholic strip water leaves contactor 24 via manifold line 150 to the tops of stripping contactors 28 and 30. A flow control needle valve 110 adjusts the overall flow of strip water and the pressure in line 150 as measured at pressure transmitter 160. Isolation valves 152 and 154 are used to control the flow of water to the tops of the contactors 28 and 30. Preferably flow would be arranged so that stripping water flows through the two contactors 28 and 30 in parallel.

Preferably the pressure as measured at transmitter 160 on line 150 should be lower than the pressure in the permeate line 48 as measured at transmitter 70. The flow rates in each of lines 172 and 174 are monitored by rotameters 176 and 178 respectively and are controlled by the degree of opening of valves 152 and 154.

It has been found that the efficiency of alcohol extraction in the stripping contactors 28 and 30 is improved if both the permeate and the strip solution have carbon dioxide and oxygen removed therefrom. As described previously, vacuum pump 40 draws a vacuum on lines 42, 44 and 46 and on the lumen side of contactors 24 and 26. Typically the pressure in the line 42 as measured by pressure transmitter 180 is −80 kPa to −95 kPa.

The system is arranged such that water from break tank 84 maintains a supply of service (sealing and cooling) water to vacuum pump 40. The exhaust gases and service water which are ejected by the vacuum pump pass through line 182 to surge tank 98 where the gases including the nitrogen strip gas from line 44 and the carbon dioxide and oxygen extracted from contactors 24 and 26 are expelled to the atmosphere. Some minor amounts of alcohol from the permeate in contactor 26 are also expelled. The water from line 182 is then available to be used for stripping purposes, so minimising the use of water by the system.

Many modifications will be apparent to those skilled in the art without departing from the spirit and scope of the invention.

What is claimed is:

1. A method for reducing the alcohol content of a wine comprising:
(i) processing the wine having a first alcohol concentration by reverse osmosis or nanofiltration to produce a retentate and a raw permeate, the retentate having a second alcohol concentration greater than or equal to the first alcohol concentration, and the raw permeate having a third alcohol concentration less than or equal to the first alcohol concentration;
(ii) heating the raw permeate to a temperature greater than the temperature of the wine being processed;
(iii) heating strip water to a temperature greater than the temperature of the wine being processed;
(iv) after heating the raw permeate, contacting a first side of an hydrophobic microporous membrane with the heated raw permeate;
(v) after heating the strip water, contacting a second side of the hydrophobic microporous membrane with the heated strip water, extracting alcohol from the raw permeate, and forming a partially dealcoholized permeate having a fourth alcohol concentration at the first side of the hydrophobic microporous membrane; and
(vi) combining the retentate with the partially dealcoholized permeate and forming a partially dealcoholized wine having a fifth alcohol concentration less than the first alcohol concentration.

2. The method of claim 1 wherein one or both of the raw permeate and strip water is heated to a temperature in the range of about 40° C. to about 70° C.

3. The method of claim 1 wherein one or both of the raw permeate and strip water is heated to a temperature in the range of about 45° C. to about 55° C.

4. The method of claim 1, wherein the temperature of retentate in the reverse osmosis or nanofiltration unit is in the range of about 13° C. to about 25° C.

5. The method of claim 1 wherein the wine comprises volatile components; and
wherein after processing the wine of step (i), substantially all of the volatile components remain in the retentate.

6. The method of claim 1 wherein the third alcohol concentration is between about 75% and about 95% of the first alcohol concentration; and
wherein the fourth alcohol concentration is substantially less than the third alcohol concentration.

7. The method of claim 1 wherein the fifth alcohol concentration is between about 0.5% to about 1.5% less than the first alcohol concentration.

8. The method of claim 1 further comprising repeating steps (i)-(vi) until the fifth alcohol concentration at or below a predetermined level.

9. The method of claim 1 further comprising removing carbon dioxide and/or oxygen from the strip water prior to step (v).

10. The method of claim 1 further comprising removing carbon dioxide and/or oxygen from the raw permeate prior to step (iv).

11. The method claim 1, further comprising the step of cooling the partially dealcoholized permeate prior to step (vi).

12. The method of claim 1, wherein the raw permeate is degassed prior to step (iv) and wherein the strip water is degassed prior to step (v).

13. The method of claim 1 further comprising, prior to step (i), storing the wine in a container and after step (vi), storing the partially dealcoholized wine in the container.

14. The method of claim 1, further comprising including the steps of:
storing the wine in a tank;
pumping the wine from the tank to the reverse osmosis or nanofiltration unit for processing according to step (i); and
wherein step (vi) is carried out by returning the retentate and the partially dealcoholized permeate to the tank.

15. The method of claim 1, wherein the strip water is passed to a waste line after step (v).

16. A partially dealcoholized wine made by the method of claim 1.
